(19) United States
(12) Patent Application Publication
(10) Pub. No.: US 2024/0318785 A1
(43) Pub. Date: Sep. 26, 2024

(54) COMPACT INSERTS FOR CRYO-COMPRESSED STORAGE VESSELS

(71) Applicant: Verne Inc., San Francisco, CA (US)

(72) Inventors: David E. Jaramillo, San Francisco, CA (US); Edward J. McKlveen, San Francisco, CA (US); Anubhav Roy, San Francisco, CA (US); Kaushik Mallick, San Francisco, CA (US)

(73) Assignee: Verne Inc., San Francisco, CA (US)

(21) Appl. No.: 18/689,028

(22) PCT Filed: Sep. 2, 2022
(86) PCT No.: PCT/US22/75884

§ 371 Date: Mar. 4, 2024

Related U.S. Application Data
(60) Provisional application No. 63/240,417, filed on Sep. 3, 2021.

(51) Int. Cl. F17C 5/04; F17C 1/14; F17C 13/00

(52) U.S. Cl. CPC F17C 5/04; F17C 1/14; F17C 13/001; F17C 2201/0104; F17C 2203/0391; F17C 2203/0604; F17C 2203/0619; F17C 2203/0643; F17C 2203/0646; F17C 2205/0305; F17C 2205/0367; F17C 2209/221; F17C 2221/012; F17C 2260/013; F17C 2260/036; F17C 2270/0171

(57) ABSTRACT

In one aspect, an insert including a single metal or alloy compatible with cryo-compressed tanks is disclosed. In one embodiment, the insert contains one, two, or more tubes that extend into the inner storage volume of the tank. The insert may be integrally formed with the tubes. The tubes enable the entrance and exit of hydrogen to the inner storage volume. In one embodiment, the tank includes a boss suitable to accept the insert. The boss and the insert may be the same metal. The insert may minimize the number of welds suitable for use in on-board heavy duty storage applications. Overall, this type of insert decreases the probability of hydrogen leaks, reduces the cost of the insert as only one piece is required, and leads to faster manufacturing as fewer welds are required.

### CROSS-REFERENCE TO RELATED APPLICATIONS

The present application claims priority to U.S. Patent Application No. 63/240,417 filed Sep. 3, 2021 and entitled “UNITARY THREADED INSERTS FOR CRYO-COMPRESSED STORAGE VESSELS,” the entirety of which is incorporated herein by reference for all purposes.

### TECHNICAL FIELD

The present application relates to pressure storage vessels. In particular, the present application relates to cryo-compressed storage vessels.

### BACKGROUND

Decarbonization of the heavy-duty transportation sector is a daunting global challenge that must be addressed in the coming years to prevent climate catastrophes. This is a remarkably difficult problem, as the general strategy of electrification using batteries for energy storage is not sufficient to fully decarbonize heavy-duty transportation in trucks, maritime, rail, aviation, and other modes of transportation. A denser energy carrier than electrons stored in batteries is required to address this problem across all transportation industries at a scale large enough to have meaningful climate impacts. One promising solution is to use hydrogen as a fuel. Hydrogen has a gravimetric energy density of 33 kWh/kg, which is about three times greater than that of diesel. At a system level, hydrogen storage exhibits 20-40× greater gravimetric energy density relative to lithium-ion battery technology which is around 100-200 Wh/kg. Furthermore, storing hydrogen is predicted to be around ten times less expensive than batteries on a gravimetric basis (e.g., about $80 kWh/kg for batteries vs. about $8 kWh/kg for hydrogen).

However, due to the complexity in storing hydrogen, which requires heavy and large storage systems, the overall system energy density is much lower than many typical battery systems. Thus, one challenge facing hydrogen storage systems is the development of hardware systems that exhibit high volumetric and gravimetric density. Most commonly, hydrogen can be stored on-board vehicles as a compressed gas (350 to 700 bar) or as a liquid (20-33 K). Liquid hydrogen systems offer a superior volumetric density to compressed gas, at about 1.5 kWh/L, which is at least three times greater than the volumetric density of lithium-ion batteries. However, hydrogen liquefaction is expensive, and the storage of liquid hydrogen suffers from boil-off events and complicated refueling procedures. A promising alternative is to store hydrogen in its supercritical cryogenic state, using tanks known as cryo-compressed storage vessels. Cryo-compressed, also known as supercritical cryogenic, hydrogen storage offers densities comparable to, and even higher than, that of liquid hydrogen, while avoiding boil-off issues and featuring a simple refueling procedure. Tanks for storing cryo-compressed hydrogen typically operate at moderate to high pressures and cold to cryogenic temperatures, presenting design and construction challenges relative to standard hydrogen storage technologies.

For cryo-compressed tanks to meet the application parameters for heavy-duty applications, the tank, the tank system, and the balance of tank system components should be designed to minimize potential failure modes. For example, this will be necessary to meet the long service lifetimes in hydrogen trucking (1.2 M miles driven) and the DOE targets for storage system cycles of 11,000. Currently, meeting these application parameters remains a challenge for supercritical hydrogen storage. Cryo-compressed tanks often use designs and/or parts adapted from liquid hydrogen and/or from compressed hydrogen tanks and systems. This approach results in tanks and systems that are not optimized for the operating conditions of cryo-compressed storage. Optimizing these parts for cryo-compressed hydrogen may boost storage densities and enable the development of solutions that can be introduced into the heavy-duty transportation market at scale. In particular, prior art cryo-compressed tanks typically include different metals and alloys, most commonly aluminum and stainless-steel alloys. The use of multiple metals and parts introduces substantial difficulties in the threaded insert component that plugs or provides fluid access to the vessel interior, such as the need to have many weld points and bimetallic welding procedures. This can increase manufacturing steps, make it difficult to do serial production of inserts, increase failure modes, and overall increase cost.

FIGS. 1A, 1B, and 1C illustrate an example of a prior art tank 100 for cryo-compressed hydrogen storage. An inner volume 102 serves as the storage space for hydrogen. The inner volume 102 is surrounded by a liner 103, typically metallic, but it can also be non-metallic materials, such as polymeric materials (e.g., polyethylene). The liner 103 is surrounded by a support layer or overwrap 104, which is typically a composite material, such as carbon fiber and an epoxy resin matrix. The liner 103 and the overwrap 104, which encapsulate the inner volume 102, form an inner vessel 115. The inner vessel can be a type III vessel, as is known in the art, as an example. Surrounding the overwrap 104 is an insulation layer 105 which is typically a high-vacuum (e.g., 10⁻⁵ torr) layer which may contain insulating materials, such a metal foil, and/or fiberglass, or may contain a vacuum with no additional insulating materials. The insulation layer 105 helps ensure that the hydrogen in 102 remains at desired temperatures (e.g., 33 K-233 K) to maintain the hydrogen in the supercritical state. Surrounding the insulation layer 105 is an outer wall or jacket 106, which is typically metallic although may be formed of other materials. In addition to enclosing the insulation layer 105, the jacket 106 helps protect the inner vessel 115 from external forces. One or more support rings 107, may be disposed between the inner vessel 115 and the jacket 106, which prevent the inner vessel from moving around and contacting the jacket 106. The tank 100 may be coupled to a valve 108 that can be used to connect to a vacuum system to establish a vacuum environment in the insulation layer 105. Hydrogen can move in and out through a multi-metallic insert 109 and into the storage space 102.

The prior art insert 109 is made up of multiple metals (e.g., aluminum 6061, stainless steel 304, titanium, and copper). Typically, the prior art uses type three hydrogen storage pressure vessels as the inner vessel, which have an aluminum liner. As aluminum is very thermally conductive and a relatively weak metal, stainless steel inlet and outlet tubes are used to minimize wall thickness, weight, and heat transfer, in order to keep the hydrogen at cryogenic to low temperatures. Stainless steel and aluminum thus must be joined, and this presents a challenge. The current solution is expensive as it requires a specialized welding technique, explosive welding, and requires other metals, such as titanium or copper, which serve as the interlayer to help join the two dissimilar metals, aluminum and stainless steel. The insert 109 contains threads and is threaded into the inner vessel 115. In this example, there is a bottom portion of the insert 110 which is one type of metal or alloy, for example stainless steel. The insert 109 includes a top portion 111 which is a different type of metal or alloy, for example aluminum. The insert includes tubes 12a and 12b where hydrogen can move in or out of the storage space 102. For example, one of the tubes can be used for refueling cryo-compressed hydrogen while the other tube serves as a venting line. The tubes 12a and 12b are joined to the insert 109 by welds 113. The welds 113 also help reduce or prevent hydrogen leaks, such that hydrogen can only enter or exit the storage space 112 through the tubes 12a and 12b. One or more of the tubes 12a and 12b may be connected to and controlled by respective downstream valves. The insert 109 is joined to the inner vessel 115 by weld 114 between the top portion of the insert (typically aluminum) and the liner (typically aluminum). The weld between the tank and the insert is difficult to manufacture in a serial process relative to welding within the insert piece alone.

The multi-metallic or multi-alloy nature of a prior art insert introduces various failure modes and adds manufacturing complexity and cost. The difference in the thermal expansion and densities of the different metals used can eventually lead to leaks from accumulation of thermal and mechanical stresses. Furthermore, the bimetallic welding process may lead to formation of brittle intermetallic phases, which introduces additional failure points. Such intermetallic phases may be particularly problematic for inserts that require stainless steel and aluminum components, as expensive and specialist approaches are required to weld these distinct alloys. This increases costs and introduces the possibility of brittle phase formation.

Prior art inserts can also be of a single metal or alloy, but they are still a multicomponent piece. For example, every tube needs to be welded to the insert. As a prior art threaded insert is two or more pieces, it necessitates multiple additional welds. Every additional weld used drives up manufacturing complexity and cost and increases failure modes. Thus, an improved tank insert that is optimized for cryo-compressed operations is desired. Herein, we describe various embodiments that address some or all of these important issues.

### SUMMARY

In accordance with one embodiment a unitary insert with one or more ducts and with one or more tubes is described. In a preferred embodiment the unitary insert is optimized for cryo-compressed hydrogen storage vessels. The insert is a continuous piece of metal, for example stainless steel, or aluminum. It minimizes the number of welds required for cryo-compressed vessel construction, decreasing the number of failure points, and allows for an overall more compact vessel design.

In one embodiment, an apparatus for use in hydrogen pressure vessels is disclosed. The apparatus includes an insert including a continuous body formed of a single metal or alloy, wherein the insert is formed without welds; threads formed on the body and configured to engage with mating threads of a pressure vessels one or more ducts formed within the body and configured to provide a passage for hydrogen or fluids between opposing ends of the body; wherein, the insert is configured to be coupled to a pressure vessel with only one weld to produce a sealed inner pressure vessel.

Optionally in some embodiments the apparatus includes one or more tubes which extend the one or more ducts beyond the body, and wherein the one or more tubes are formed as part of the continuous body without any additional welds coupling the one or more tubes to the body.

Optionally in some embodiments the single metal or alloy comprises stainless steel.

Optionally in some embodiments the single metal or alloy comprises aluminum.

Optionally in some embodiments the one or more ducts includes a sharp or mitered bend.

Optionally in some embodiments the apparatus includes one or more grooves formed in the body portion and configured to accommodate a support structure.

A unitary fluidic connection device is disclosed. In one embodiment, the unitary fluidic connection device includes a body portion including a first end and a second end opposite the first end thereof; threads formed on an outer portion thereof; a flange portion including a first end and a second end opposite the first end thereof. The flange portion extends longitudinally and axially from the first end of the body portion, and the flange portion has a radial dimension larger than a radial dimension of the body portion; a plurality of ducts extending longitudinally through flange portion and through the body portion between the first end of the flange portion and the second end of the body portion; a respective plurality of first conduits extending longitudinally from respective first ends of each of the plurality of ducts proximate to the first end of the flange portion; a respective plurality of second conduits extending longitudinally from respective second ends of each of the plurality of ducts proximate to the second end of the body portion.

Optionally in some embodiments, the unitary fluidic connection device includes stainless steel.

Optionally in some embodiments, the unitary fluidic connection device includes aluminum.

Optionally in some embodiments, the unitary fluidic connection device includes one or more grooves configured to accommodate a support structure.

In one embodiment, a pressure vessel fluid coupling includes an upper portion including: a first sub-portion including a first conduit receptacle, and a second sub-portion including a second conduit receptacle; a lower portion configured to be coupled to the upper portion; a conduit configured to be received in the first conduit receptacle and the second conduit receptacle, wherein the conduit is configured to provide a fluid pathway to an internal volume of the pressure vessel.

Optionally in some embodiments, the pressure vessel fluid coupling includes: first threads formed on an outer surface of the first sub-portion; and second threads formed on an outer surface of the second sub-portion, wherein when the first sub-portion and the second sub-portion are assembled together, the first threads and the second threads form a single helix.

Optionally in some embodiments, the upper portion is formed of a first material and the lower portion is formed of a second material different than the first material.

Optionally in some embodiments, the first material comprises aluminum or an alloy thereof and the second material comprises steel or an alloy thereof.

Optionally in some embodiments, the first sub-portion includes a first flange portion; and the second sub-portion includes a second flange portion. When the first sub-portion and the second sub-portion are assembled together, first flange portion and the second flange portion form a recess.

Optionally in some embodiments, the lower portion includes a protrusion that rises proud of the main body of the lower portion.

Optionally in some embodiments, the protrusion is receivable in the recess such that the protrusion and the recess comprise respective first and second attachment portions configured to couple the upper portion and the lower portion together.

Optionally in some embodiments, the conduit includes a mitered bend.

Optionally in some embodiments, the conduit is coupled to the lower portion by a weld that forms a hermetic seal.

Optionally in some embodiments, a pressure vessel system includes: a pressure vessel, including a neck with neck threads formed on an inner surface thereof, an internal compartment a pressure vessel fluid coupling as described herein; a radial seal received in a gland formed in the lower portion and configured to contain a fluid within the internal compartment, wherein when the single helix is threadedly engaged with the neck threads, the radial seal prevents the leakage of a fluid from the internal compartment.

### BRIEF DESCRIPTION OF THE DRAWINGS

FIG. 1A, FIG. 1B, and FIG. 1C illustrate the prior art cryo-compressed storage tank with the prior art insert.

FIG. 2 shows a sectional view of one embodiment of a cryo-compressed storage tank insert of the present disclosure.

FIG. 3 shows a sectional view of another embodiment of a cryo-compressed storage tank insert of the present disclosure.

FIG. 4 shows a sectional view of another embodiment of a cryo-compressed storage tank insert of the present disclosure.

FIG. 5 shows a sectional view of an embodiment of a cryo-compressed storage tank insert of the present disclosure.

FIG. 6 shows a top-down view of an embodiment of the insert of the present disclosure

FIG. 7 shows a longitudinal cross-sectional view of an embodiment of a suitable inner vessel and the insert of the present disclosure

FIG. 8A shows an isometric view of an embodiment of a cryo-compressed storage tank insert.

FIG. 8B is a section view of the insert of FIG. 8A taken along line 8B-8B of FIG. 8A.

FIG. 8C is a partially exploded view of the upper portion of the insert of FIG. 8A, depicting the two sub-portions of the upper portion.

FIG. 8D is a partially exploded view of the tank insert of FIG. 8A depicting the lower portion being joined to the upper portion.

FIG. 8E is a partial section view of the insert of FIG. 8A assembled with a pressure vessel.

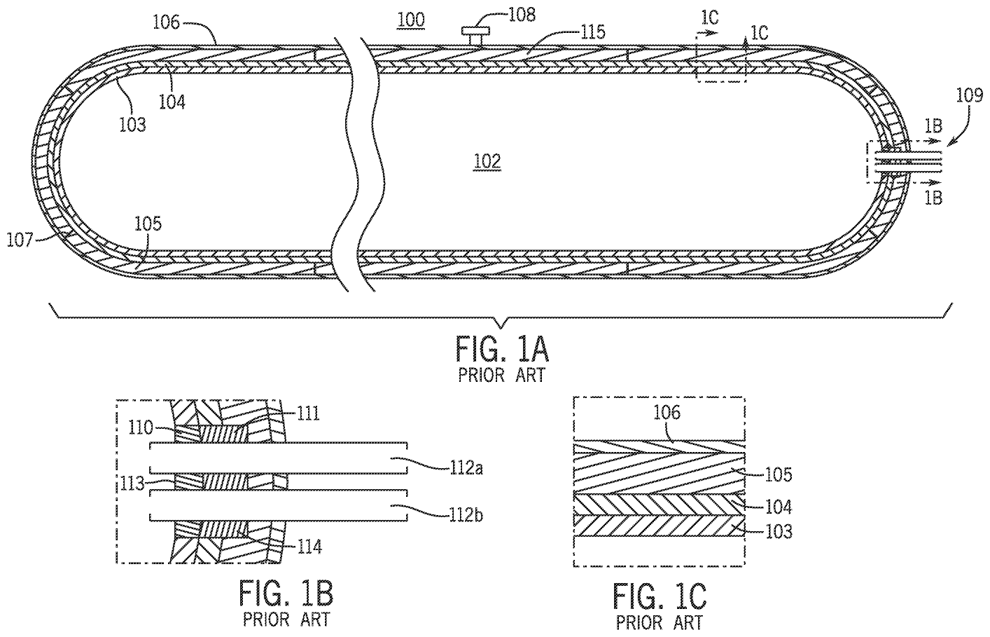

### DETAILED DESCRIPTION

The present disclosure is directed to devices and methods to address the issues and limitations of the existing devices and methods discussed herein. In one embodiment, a tank insert is formed by additive manufacturing to produce a single, continuous, metallic and unitary threaded insert piece suitable for use with a cryogenic pressure vessel. A pressure vessel can contain a pressurized fluid (a liquid, gas, or supercritical fluid). In a preferred embodiment the pressure vessel is optimized to store cryo-compressed hydrogen. As used herein, unitary describes a device made from a single piece of material. In many embodiments, the metal or alloy used has a very low-to-undetectable permeability to hydrogen under the operating conditions, which may include large swings in temperature (e.g., 33-298 K) and pressure (e.g., 5-350 bar). Furthermore, in many embodiments, it may be desired that the metal or alloy has a fatigue life of over 11,000 discharge and refueling cycles while minimizing weight or bulk of the overall storage system. Single metallic, stainless steel alloys are promising for this use. Only recently, additive manufacturing techniques have been developed that make it possible to produce various alloys, including stainless steel, that are non-porous and feature yield strength and tensile ductility comparable to or even superior to conventionally made alloys. In particular, the application of laser powder-bed-fusion (“LPBF”) technique may be able to produce inserts of sufficient strength and ductility to meet the application parameters (11,000 cycles of 33-298 K and 5-350 bar swings) of on-board cryo-compressed hydrogen storage for transportation applications. This type of technique gives rise to non-equilibrium microstructures that contribute to the overall bulk material properties. Due to the contributions from these non-equilibrium microstructures, this method can impart greater yield strength and uniform elongation relative to counterparts made from standard manufacturing processes such as machining, casting, and/or forging. The laser processing parameters directly impact the peak temperature, thermal gradient, and cooling rate, which influence the resulting microstructures and bulk properties. By establishing preferred laser processing conditions, such as spot size, power, and scan speed, tank components can be constructed with the appropriate bulk properties (e.g. yield strength>200 MPa) at sufficient throughput. For example, laser spot sizes can range from 50 to 1000 μm, laser power can range from 100 to 1000 W, and the scan speed can range from 100 to 5000 mm/s. A combination of laser-based additive manufacturing methods, including powder feed (e.g., Direct Energy Deposition or “DED”) and wire feed setups, can enable the production of stainless steel at the various sizes and durability traits desired. In addition to LPBF and other laser-based additive manufacturing approaches, another strategy is to cast or use metal injection modeling to construct the insert piece. However, there may be difficulties with casting the tubes of particular lengths and particular shapes (i.e. bends).

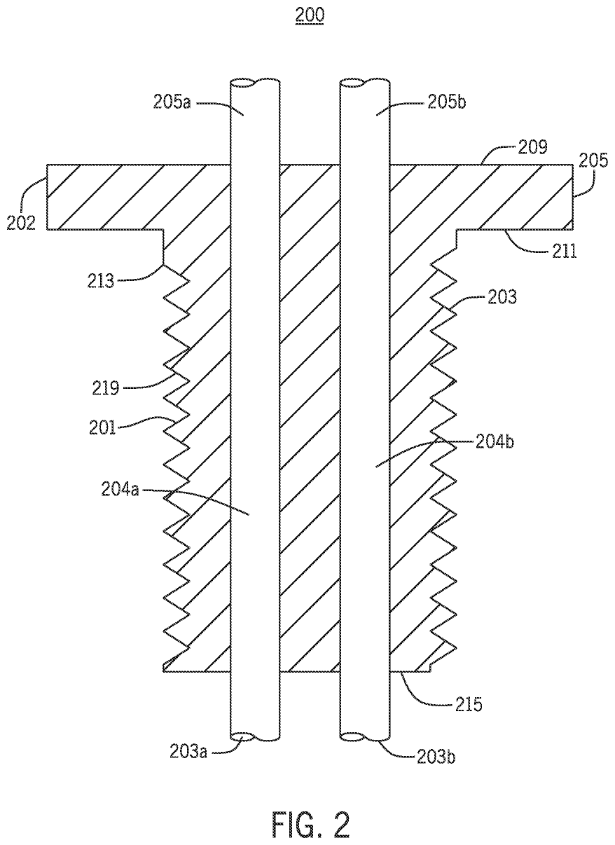

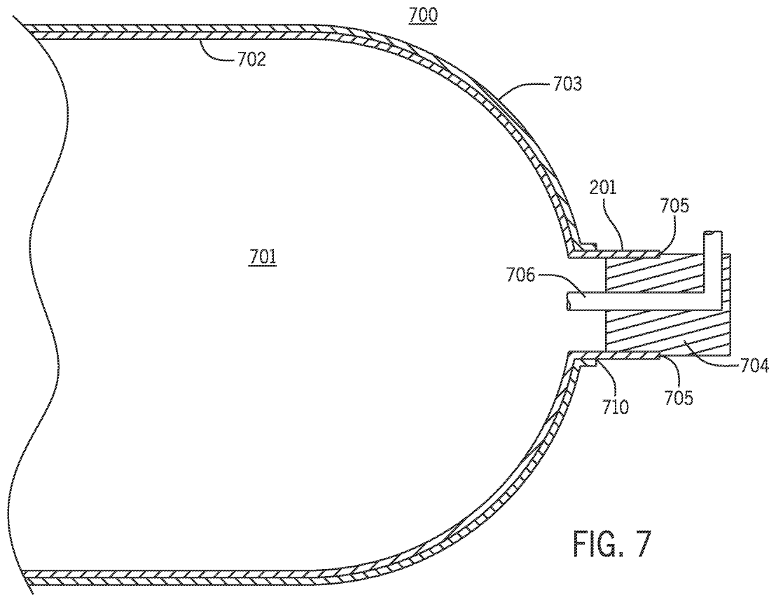

One embodiment of the present disclosure is illustrated in FIG. 2. A threaded insert, 200, is one metal or alloy, preferably stainless steel (e.g. 304L or 316L), although it could also be other metals or alloys, such as aluminum (e.g. 6061), and is one continuous piece as manufactured, for example, by additive manufacturing techniques (e.g., LPBF, DED, or other additive manufacturing techniques). In many embodiments, the insert may be formed of a single piece such as by using additive manufacturing techniques (e.g., LPBF, DED). The insert may be formed without any welds. In many embodiments, the insert 200 can have a cylindrical body portion 203 and a flange portion 205. The cylindrical body portion 203 may have a first end 213 and a second end 215 disposed longitudinally with respect to the first end 213. The flange portion 205 may have a first end 209 and a second end 211 disposed longitudinally with respect to the first end 209. The flange portion 205 extends longitudinally and axially from the first end 213 of the body portion 203. The flange portion 205 may have a radial dimension larger than a radial dimension of the body portion 203. The insert 200 may have threads 201 formed on an outer surface 219 of the cylindrical body portion 203. The threads 201 may be used to couple the insert 200 into a neck 710 of the inner vessel (FIG. 7).

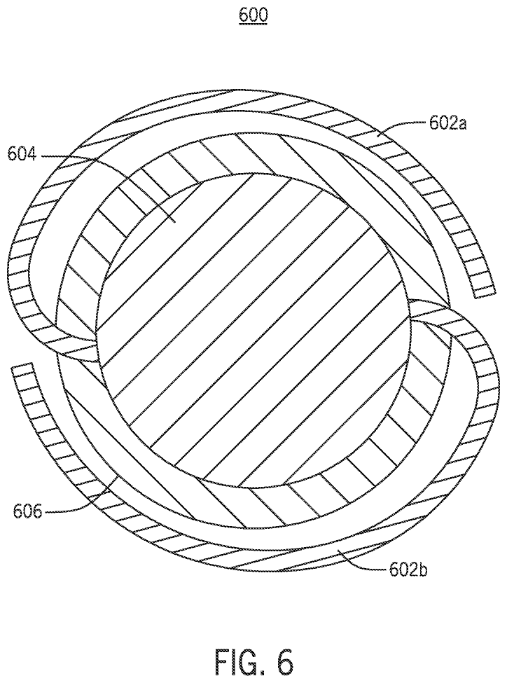

The insert 200 and the threads 201 can be compatible with current type III vessels, which can serve as the inner vessel for cryo-compressed storage units. Once inserted into the neck 710, the threads 201 of the insert 200 help withstand stresses that arise when the inner volume 701 contains a pressurized fluid. Adjacent to the threads 201 and the cylindrical body portion 203, the flange portion 205 of the insert 200 may have a wider dimension than the body portion 203. The flange portion 205 may act as a collar, support base, or shoulder 202. In many embodiments, the shoulder 202 serves as support for joining the insert 200 to the inner vessel, by a joint that may be formed such as by welding, soldering, brazing, or the like. For example, as shown in FIG. 7, the insert 200 or 300 may be joined to a tank 700 by a joint 705 at the neck. The joint 705 which in many embodiments may follow the circumference of the insert 200, may be the only joint that connects the insert 200 to the rest of the storage vessel 700. Preferably, the unitary insert is the same metal or alloy as the neck. In one preferred embodiment, the liner and the insert are stainless steel. In another embodiment, the liner is aluminum, as is most common today in Type III vessels, and the insert may then also be aluminum. Note that the aluminum tubes may extend longer in the vacuum layer to mitigate heat transfer into the inner vessel, relative to the stainless steel version. For example, they can wrap around the insert as shown in FIG. 6.

The single-piece insert 200 may contain one or more ducts 204a, 204b. As shown for example in FIG. 2, the ducts 204a, 204b may extend beyond the main body of the insert 200, and transition to the corresponding tubes or conduits 205a and 205b with which the ducts 204a, 204b are in fluid communication. The ducts 204a, 204b may extend longitudinally through the flange portion 205 and through the body portion 203 between the first end 209 of the flange portion 205 and the second end 215 of the body portion 203. Conduits 205a, 205b may extend longitudinally from respective first ends of each of the ducts 204a, 204b proximate to the first end 209 of the flange portion 205. Conduits 203a, 203b may extend longitudinally from respective second ends of each of the ducts 204a, 204b proximate to the second end 215 of the body portion 203. The conduits or tubes 203a, 203b, 205a, and 205b may be integrally formed with the insert 200. An advantage of integral forming of the tubes with the insert 200 is that the tubes do not include a joint (e.g., a weld, braze, solder, or the like) with the insert 200 and thus do not create potential leak or failure point, and decreases the number of steps in manufacturing. The tubes 203a, 203b, 205a, and 205b may be used for fluid flow in and out of the tank. For example, one tube 205a or 205b may be used to supply supercritical hydrogen to the tank 200, while the other tube 205a or 205b may evacuate or vent hydrogen gas generated as the supercritical hydrogen absorbs heat from the tank 200.

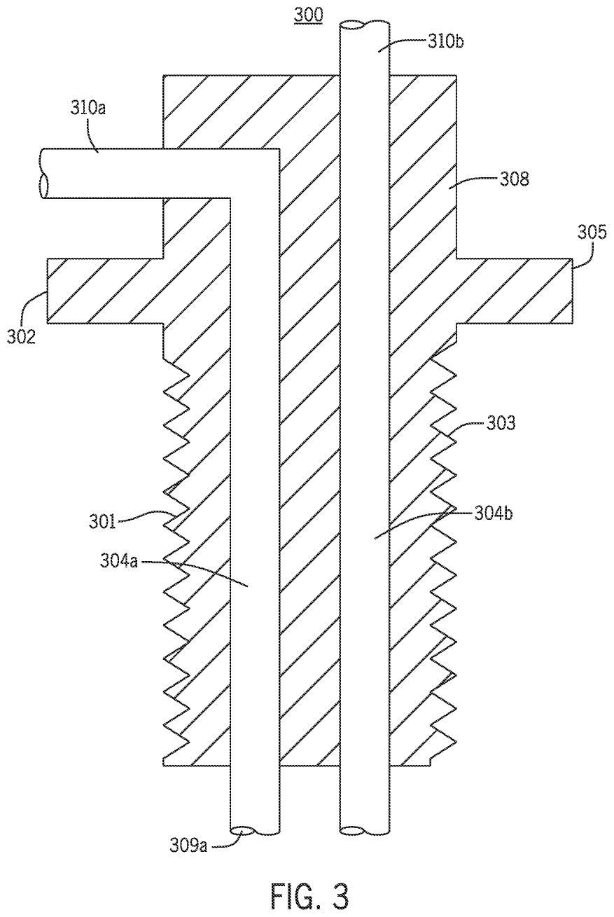

FIG. 3 shows another embodiment of an insert 300. The insert 300 may be substantially similar to the insert 200 in some aspects. For examples, the insert 300 may include a first body portion 303 and a flange portion 305. The insert 300 may have formed therein one or more ducts 304a, 304b. The insert may be integrally formed with one or more tubes 310a, 310b, 309a. The tubes may have bends. The insert 300 may include a second body portion 308. The body portions 303 and 308 may be cylindrical, prismatic or have other shapes. In many embodiments, the body portion 303 is cylindrical and includes threads 301 similar to the threads 201. In some embodiments, the flange portion 305 may be disposed between the body portion 303 and the body portion 308. In some embodiments, the insert 300 may not include a body portion 308 that extends from the flange portion 305. One or more ducts 304a, 304b may be straight or may have a bent or curved shape to facilitate connections to the tank. For example, the duct 304a can have a bend resulting in a near perpendicular exit or entrance. This bend can be more obtuse. A duct, 304a and/or 304b, can extend outward from either the first body portion 303 and/or the second body portion 308 resulting in a tube, such as tube 310a and/or 310b. Tubes 310a and 310b extend outward from the insert 300, such as to facilitate the coupling of fluid supply and/or vent conduits, valves, or other equipment thereto. Tube 310a may have a tight bend that can enable the tube to be wound around tightly and compactly by the tank neck, which can help to minimize heat transfer from the environment to the tank without decreasing the overall system volumetric density. Additionally, the insert body 308 can serve to provide extra mechanical support for the ducts 304a, 304b, in particular near bends. The tubes 309a is configured to extend into a tank or vessel, such as the vessel 700 shown for example in FIG. 7.

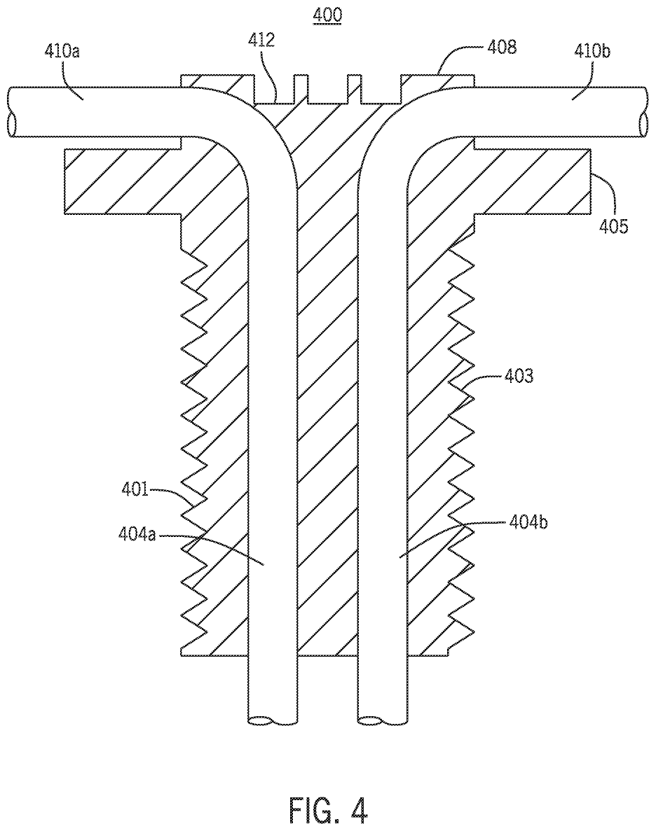

FIG. 4 shows another embodiment of an insert, 400. The insert 400 may be substantially similar to the insert 300 in some aspects. The insert 400 may have formed therein one or more ducts 404a, 404b and contain threads 401. The insert may be integrally formed with one or more tubes 410a, 410b. In some embodiments, the flange portion 405 may be disposed between the body portion 403 and body portion 408. The body portion 408 may contain grooves 412 which accommodate placement of support rings and support structures. This leads to a more stable and compact overall inner vessel design.

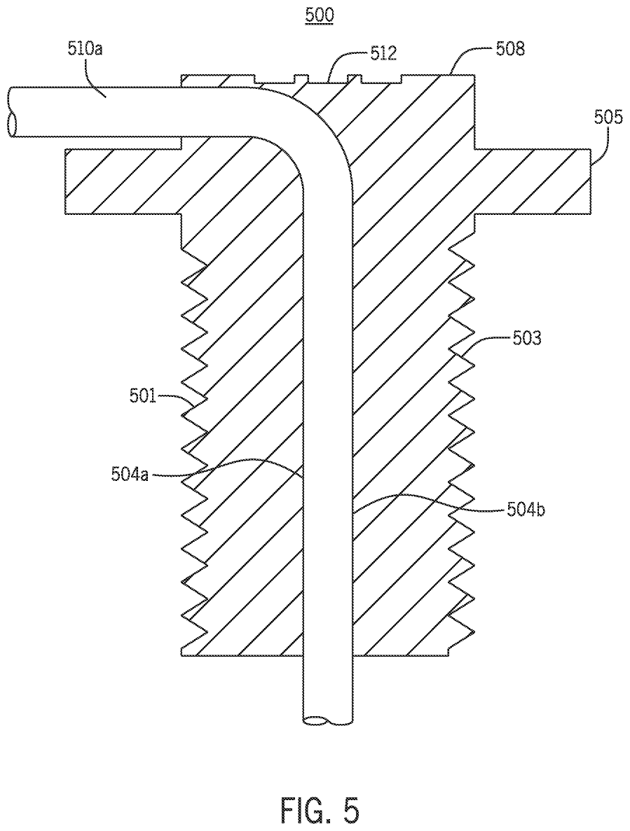

FIG. 5 shows another embodiment of an insert, 500. The insert 500 may be substantially similar to the insert 400 in some aspects. The insert 500 may have formed therein one duct 504a and contain threads 501. The insert may be integrally formed with one tube, 510a. The flange portion 505 may be disposed between a body portion 503 and an upper body portion 508. The upper body portion 508 houses grooves which can accommodate support structures (e.g. insulating rings, cages, support rods), leading to a more stable and compact structure.

FIG. 6. shows a top-down view of one possible embodiment, insert 600. An insert flange 606, may be cylindrical, and above it, may exist an upper body 604. The insert may be integrally formed with one, two, or more tubes, 602a, 602b. The tubes may curve compactly around the insert to increase tube length while not increasing the amount of volume required to contain the tubes.

FIG. 7 displays another embodiment of the insert joined to an inner vessel. In this example, an inner volume 701 is enclosed by a metallic liner 702. The metallic liner is surrounded by a composite overwrap 703. The metallic liner can be stainless steel or aluminum, for example. An insert 704, which may be substantially similar to insert 500, is joined to the metallic liner by threading and subsequently a circumferential weld 705. The insert 704 is of the same metal as the liner 702. A tube 706 is of the same material as the insert, and integrally formed, and enables fluidic flow into and out of the tank. The insert may contain fewer or more ducts and tubes. The tube can extend and bend in various shapes.

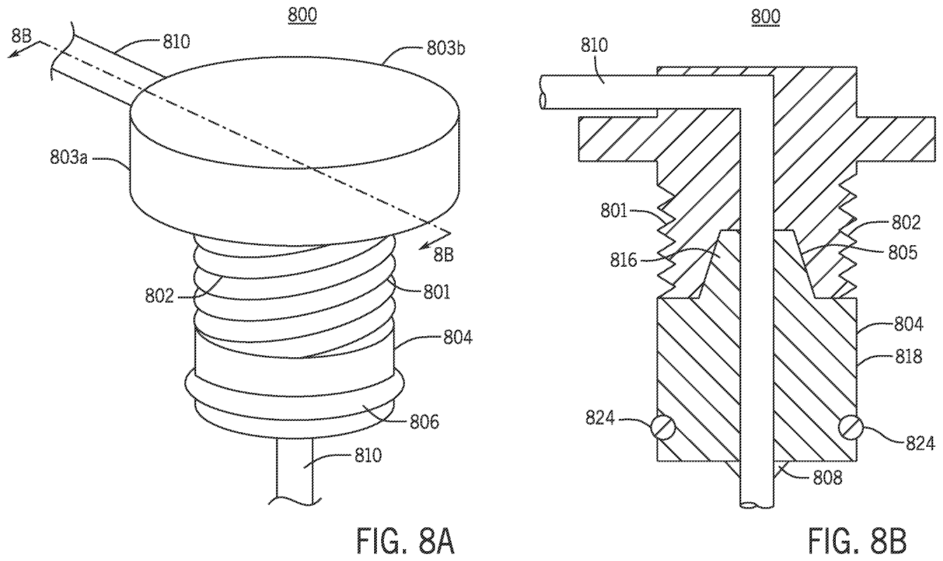

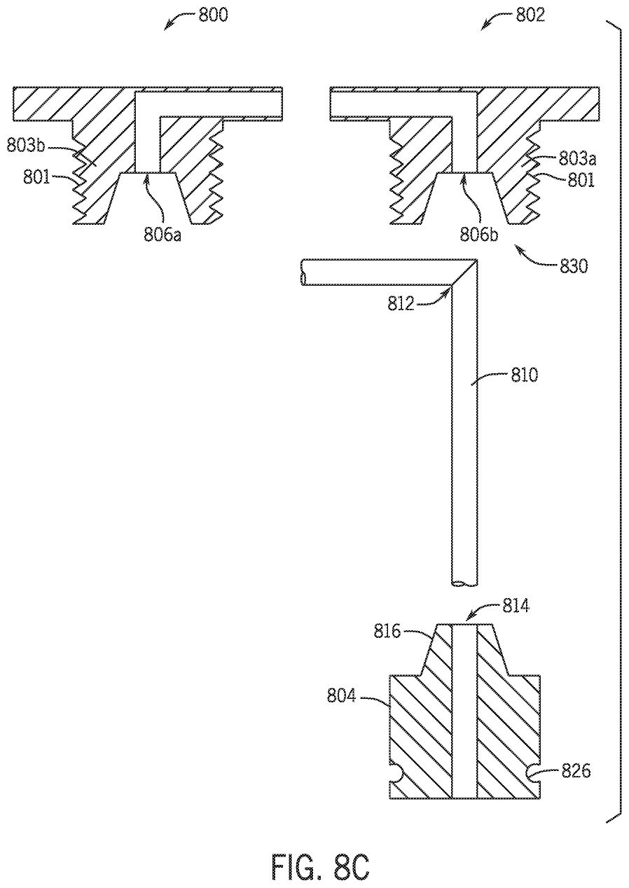

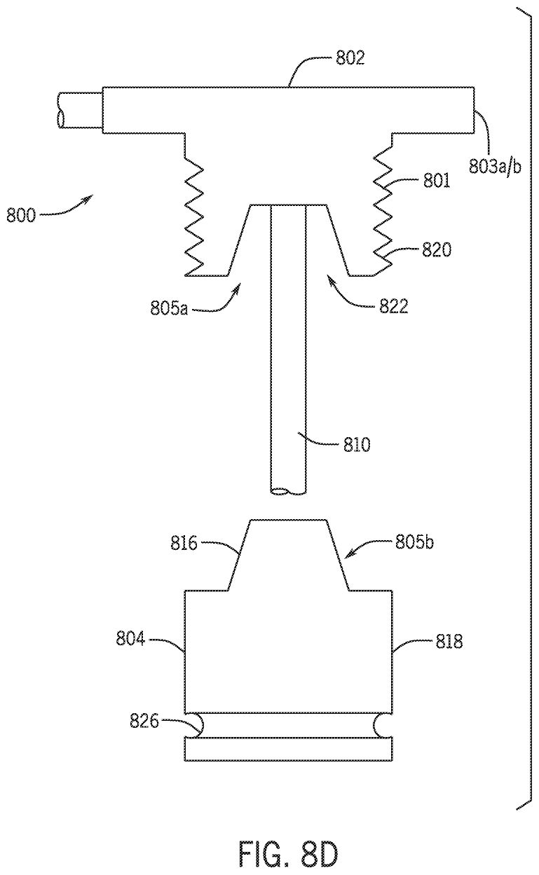

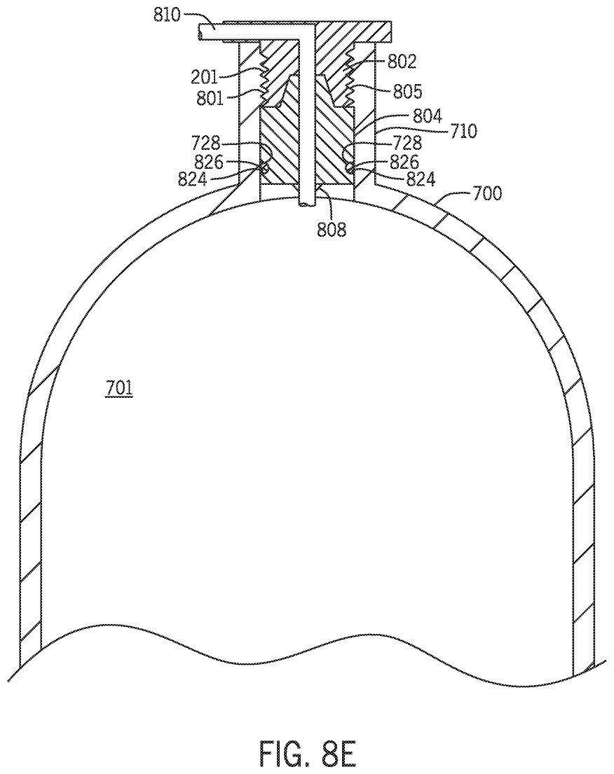

With reference to FIGS. 8A-8E, an embodiment of a compact pressure vessel fluidic coupling or tank insert 800 is disclosed. The insert 800 may be constructed of multiple pieces to facilitate easier manufacturing and assembly. The top portion 802 of the insert 800 may include two sub-portions 803a and 803b that may be individually formed by any method disclosed herein (e.g., additive manufacturing such as DED, LPBF, machining, casting, molding, machining, forging, etc.). In some embodiments, the two sub-portions 803a/b may each form approximately half of the upper portion 802. In other embodiments, one of the sub-portions 803a/b may form a larger percentage or fraction of the upper portion (e.g., about 60%) and the other of the sub-portions 803a/b may form a smaller percentage of fraction of the upper portion (e.g., about 40%). The relative sizes of the two sub-portions 803a/b may be varied between about 99% and 1% of the upper portion 802, with the other of the two sub-portions 803a/b comprising up the remaining percentage or fraction. For example, if the first sub-portion 803a/b comprises X% of the upper portion 802, the other of the sub-portions 803a/b may comprise 100-X% of the upper portion 802.

The two sub-portions 803a/b may have threads 801 formed on an outer surface thereof and configured to engage threads 201 formed in a neck 710 of a tank 700 to secure the insert 800 to the tank 700.

Each of the two portions 803a/b may have formed therein, respective conduit receptacle 806a/b. The conduit receptacle 806a/b may form a clamp structure 830 suitable to accept a conduit 810 (e.g., a fill conduit and/or a vent conduit) when the two portions are assembled, as shown for example in FIGS. 8A and 8D). In some embodiments, the conduit 810 may include a bend 812 formed therein. The conduit receptacle 806a/b may be sized and shaped to accept the conduit 810 (e.g., may form a negative impression or depression into which the conduit 810 may be received). In some embodiments, the bend may be a sharp bend (e.g., a mitered bend) or a bend radius that is less than three times the conduit diameter, for example a bend radius less than 1.5 inches for a 0.5-inch diameter tube, or less than 1 inch for 0.5-inch diameter tube. The two sub-portions 803a/b each include two or more conduit receptacles. For example, such embodiments may provide for both fill and vent conduits from the pressure vessel.

This system and approach enable the conduit 810 to maximize the compactness of the insert 800 and conduit 810. The lower portion 804 of the insert 800 may be constructed as a single piece. A conduit 814 may be formed in the lower portion 804, such as by drilling, additive manufacturing or the like, and configured to accept a portion (e.g., straight portion) of the fill conduit 814. The upper portion 802 may include an attachment portion 805a configured to receive a complementary attachment portion 805b of the lower portion 804, for example after the two sub-portions 803a and 803b have been assembled with the conduit 810. The lower portion 804 may include a protrusion 816 that rises proud of the main body 818 of the lower portion 804, thereby creating the attachment portion 805b. Similarly, the upper portion 802 may include a flange portion 820 that forms a recess 822 included in the attachment portion 805a. The protrusion 816 may be receivable in the recess 822. For example, each of the two sub-portions 803a/b may include respective first and second flange portions 820 that, when the sub-portions 803a/b are assembled cooperate to form the recess 822. For example, the flange portion 820 may surround a portion of the protrusion 816. The attachment portions 805a/b may include a threaded connection, an interference fit, a conical fit for example with a keyed entry, a sealed joint, a bonded joint, or any combination thereof.

In one example, the inert 800 may be assembled by placing the conduit 810 within one of the respective conduit receptacle 806a/b of one of the two sub-portions 803a/b of the upper portion 802. The other of the two sub-portions 803a/b may be placed over the conduit 810 such that the conduit is received in the clamp structure 800 formed by the respective two conduit receptacle 806a/b. The threads formed on an outer surfaces of the two sub-portions 803a/b may, when assembled form a single helix suitable to threadedly couple the upper portion 802 with the threads 201 of the neck 710 of the pressure vessel 700. The lower portion 804 and the assembled upper portion 802 may be joined by the attachment portions 805a/b. The lower portion 804 may be placed in the neck 710 of a pressure vessel 700 until the threads 801 of the insert begin to engage the threads 201 of the neck 710 of the pressure vessel 700. The insert may be rotated such that the threads 201 and the threads 801 engage, pulling the insert 800 sufficiently far into the neck 710 for the seal 824 to engage the gland 728 (if used) of the neck 710, sealing the pressure vessel 700. The conduit 810 may provide a fluid path between the internal compartment 701 of the pressure vessel 700 and other equipment separate from the pressure vessel 700. The portions of the insert 800 may be assembled in an order other than as described. Similarly, the insert 800 may be assembled with the pressure vessel 700 in an order other than as described.

In some examples, the lower portion 804 may be made from one or more steel alloys such as stainless steel alloy 304, 316L, and others. The upper portion 802 may be made from a metal or alloy different than that of the lower portion 804, such as aluminum or an alloy thereof such as 6061-T6, a 2000 series, such as 2050, a 5000 series, such as 5083, a 7000 series, such as 7475. Different thermal expansion properties from dissimilar metals can be leveraged to ensure an effective contact between the upper portion 802 and the lower portion 804.

The lower portion 804 may include a gland 826 formed therein and configured to receive a radial seal 824 that prevents the internal pressure of the tank to egress beyond the position of the radial seal 824. The radial seal 824 may include an elastomeric sealing mechanism, spring energized sealing mechanism, o-ring, or a combination thereof. The seal 824 may be rated for cryogenic temperatures. The radial seal 824 may also be received in an appropriately configured gland 728 formed in the neck 710 of a pressure vessel 700. The radial seal 824 may prevent the internal fluid from escaping into the threads of the insert and leaking out of the pressure vessel 700. The radial seal 728 enables the construction of the insert 800 in multiple pieces as the two sub-portions 803a/b of the upper portion 802 are not subjected to the pressure from the fluid in the tank that would tend to split the two sub-portions 803a/b apart.

In some embodiments, only one weld, weld 808, may be used to provide a hermetic seal against the hydrogen in a tank into which the insert 800 is inserted. The weld 808 can be stainless steel to stainless steel. As no weld is required between the bottom and the top half of the insert, a bimetallic welding process is avoided. Furthermore, the required weld is between the fill tube and the insert piece. Both are small components, which enables serial welding. In contrast, the prior art requires welding the insert to the tank. As the tank can be a large component, it makes the welding process more challenging to accomplish in a high-throughput manner.

The description of certain embodiments included herein is merely exemplary in nature and is in no way intended to limit the scope of the disclosure or its applications or uses. In the included detailed description of embodiments of the present systems and methods, reference is made to the accompanying drawings which form a part hereof, and which are shown by way of illustration specific to embodiments in which the described systems and methods may be practiced. These embodiments are described in sufficient detail to enable those skilled in the art to practice presently disclosed systems and methods, and it is to be understood that other embodiments may be utilized, and that structural and logical changes may be made without departing from the spirit and scope of the disclosure. Moreover, for the purpose of clarity, detailed descriptions of certain features will not be discussed when they would be apparent to those with skill in the art so as not to obscure the description of embodiments of the disclosure. The included detailed description is therefore not to be taken in a limiting sense, and the scope of the disclosure is defined only by the appended claims.

From the foregoing it will be appreciated that, although specific embodiments of the invention have been described herein for purposes of illustration, various modifications may be made without deviating from the spirit and scope of the invention.

The particulars shown herein are by way of example and for purposes of illustrative discussion of the preferred embodiments of the present invention only and are presented in the cause of providing what is believed to be the most useful and readily understood description of the principles and conceptual aspects of various embodiments of the invention. In this regard, no attempt is made to show structural details of the invention in more detail than is necessary for the fundamental understanding of the invention, the description taken with the drawings and/or examples making apparent to those skilled in the art how the several forms of the invention may be embodied in practice.

As used herein and unless otherwise indicated, the terms “a” and “an” are taken to mean “one”, “at least one” or “one or more”. Unless otherwise required by context, singular terms used herein shall include pluralities and plural terms shall include the singular.

Unless the context clearly requires otherwise, throughout the description and the claims, the words ‘comprise’, ‘comprising’, and the like are to be construed in an inclusive sense as opposed to an exclusive or exhaustive sense; that is to say, in the sense of “including, but not limited to”. Words using the singular or plural number also include the plural and singular number, respectively. Additionally, the words “herein,” “above,” and “below” and words of similar import, when used in this application, shall refer to this application as a whole and not to any particular portions of the application.

Of course, it is to be appreciated that any one of the examples, embodiments or processes described herein may be combined with one or more other examples, embodiments and/or processes or be separated and/or performed amongst separate devices or device portions in accordance with the present systems, devices and methods.

Finally, the above discussion is intended to be merely illustrative of the present system and should not be construed as limiting the appended claims to any particular embodiment or group of embodiments. Thus, while the present system has been described in particular detail with reference to exemplary embodiments, it should also be appreciated that numerous modifications and alternative embodiments may be devised by those having ordinary skill in the art without departing from the broader and intended spirit and scope of the present system as set forth in the claims that follow. Accordingly, the specification and drawings are to be regarded in an illustrative manner and are not intended to limit the scope of the appended claims.

### ADVANTAGES

From the description and accompanying drawings, several advantages for some embodiments in this disclosure are evident:

(a) An embodiment of the single-piece metal insert with tubes minimizes the number of welds used to produce a cryo-compressed tank
a. There is no need to weld inlet and outlet port tubes with the threaded insert itself
b. As it is all a single, unitary piece, there is no need to weld or join various components to make the insert body, as is common in the prior art.

(b) This reduction in the number of welds used may be important for meeting heavy-duty transportation application parameters, as it decreases:
a. the number of leak points in the tank;
b. manufacturing time; and
c. tank costs.

(c) The resulting insert can be threaded into existing cylinders, presenting a path towards manufacturing at scale.

(d) The unitary insert system can contain one or multiple tubes, featuring a range of shapes
a. A sharp bend in the insert duct can result in a tube that exits perpendicular to the central cylinder axis, which can mitigate heat transfer effects via the tube while maintaining high volumetric hydrogen storage densities.

(e) The insert is designed to minimize space
a. Grooves exists that can interlock with support structures in the insulation layer, resulting in an overall more compact design (f) An embodiment of the multi-piece metal insert avoids bimetallic welds
a. Bimetallic welds are expensive and can introduce leak points
b. Some embodiments use:
   i. A radial seal mechanism around a bottom piece;
   ii. An upper portion including two sub-portions each including a respective conduit receptacle portion configured to receive a conduit;
   iii. An attachment portion between the upper portion and bottom portion and configured to couple the upper portion and lower portion to one another;
   iv. A single hermetic seal between alloys of the same kind.
c. An embodiment of the multi-piece metal insert uses one weld between the fill tube and the insert body to facilitate serial welding, as these are both small components that are easily handled (relative to a tank, for example).

We claim:

1. An apparatus for use in hydrogen pressure vessels, comprising:
an insert comprising:
a continuous body formed of a single metal or alloy, wherein the insert is formed without welds;
threads formed on the body and configured to engage with mating threads of a pressure vessel
one or more ducts formed within the body and configured to provide a passage for hydrogen or fluids between opposing ends of the body;
wherein, the insert is configured to be coupled to a pressure vessel with only one weld to produce a sealed inner pressure vessel.

2. The apparatus of claim 1, further comprising one or more tubes which extend the one or more ducts beyond the body, wherein the one or more tubes are formed as part of the continuous body without any additional welds coupling the one or more tubes to the body.

3. The apparatus of claim 1, wherein the single metal or alloy comprises stainless steel.

4. The apparatus of claim 1, wherein the single metal or alloy comprises aluminum.

5. The apparatus of claim 1, wherein the one or more ducts includes a mitered bend.

6. The apparatus of claim 1, further comprising one or more grooves formed in the body portion and configured to accommodate a support structure.

7. A unitary fluidic connection device comprising:
a body portion including:
a first end and a second end opposite the first end thereof;
threads formed on an outer portion thereof;
a flange portion including:
a first end and a second end opposite the first end thereof, wherein the flange portion extends longitudinally and axially from the first end of the body portion, and the flange portion has a radial dimension larger than a radial dimension of the body portion;
a plurality of ducts extending longitudinally through flange portion and through the body portion between the first end of the flange portion and the second end of the body portion;
a respective plurality of first conduits extending longitudinally from respective first ends of each of the plurality of ducts proximate to the first end of the flange portion;
a respective plurality of second conduits extending longitudinally from respective second ends of each of the plurality of ducts proximate to the second end of the body portion.

8. The unitary fluid connection device of claim 7, wherein the fluid connection device comprises stainless steel.

9. The unitary fluid connection device of claim 7, wherein the fluid connection device comprises aluminum.

10. The unitary fluid connection device of claim 7, further comprising one or more grooves configured to accommodate a support structure.

11. A pressure vessel fluid coupling comprising:
an upper portion comprising:
a first sub-portion including a first conduit receptacle, and
a second sub-portion including a second conduit receptacle;
a lower portion configured to be coupled to the upper portion;
a conduit configured to be received in the first conduit receptacle and the second conduit receptacle, wherein the conduit is configured to provide a fluid pathway to an internal volume of the pressure vessel.

12. The pressure vessel fluid coupling of claim 11, further comprising:
first threads formed on an outer surface of the first sub-portion; and
second threads formed on an outer surface of the second sub-portion, wherein when the first sub-portion and the second sub-portion are assembled together, the first threads and the second threads form a single helix.

13. The pressure vessel fluid coupling of claim 11, wherein the upper portion is formed of a first material and the lower portion is formed of a second material different than the first material.

14. The pressure vessel fluid coupling of claim 13, wherein the first material comprises aluminum or an alloy thereof and the second material comprises steel or an alloy thereof.

15. The pressure vessel fluid coupling of claim 11, wherein:
the first sub-portion includes a first flange portion; and
the second sub-portion includes a second flange portion, wherein when the first sub-portion and the second sub-portion are assembled together, first flange portion and the second flange portion form a recess.

16. The pressure vessel fluid coupling of claim 15, wherein the lower portion includes a protrusion that rises proud of the main body of the lower portion.

17. The pressure vessel fluid coupling of claim 16, wherein the protrusion is receivable in the recess such that the protrusion and the recess comprise respective first and second attachment portions configured to couple the upper portion and the lower portion together.

18. The pressure vessel fluid coupling of claim 11, wherein the conduit includes a mitered bend.

19. The pressure vessel fluid coupling of claim 11, wherein the conduit is coupled to the lower portion by a weld that forms a hermetic seal.

20. A pressure vessel system comprising:
a pressure vessel, comprising:
a neck with neck threads formed on an inner surface thereof,
an internal compartment
the pressure vessel fluid coupling claim 12;
a radial seal received in a gland formed in the lower portion and configured to contain a fluid within the internal compartment, wherein when the single helix is threadedly engaged with the neck threads, the radial seal prevents the leakage of a fluid from the internal compartment.
